(19) United States
(12) Patent Application Publication
(10) Pub. No.: US 2014/0093300 A1
(43) Pub. Date: Apr. 3, 2014

(54) DECORATING DEVICE FOR WRITING INSTRUMENTS

(71) Applicant: Deborah Schwartzberg, Brooklyn, NY (US)

(72) Inventor: Deborah Schwartzberg, Brooklyn, NY (US)

(21) Appl. No.: 14/041,867

(22) Filed: Sep. 30, 2013

Related U.S. Application Data
(60) Provisional application No. 61/708,358, filed on Oct. 1, 2012.

(51) Int. Cl. B43K 29/00

(52) U.S. Cl. CPC B43K 29/00
USPC 401/195; 428/542.2

(57) ABSTRACT

A decorative writing instrument includes a writing instrument and a resilient member having an opening therein. The writing instrument is disposed within the opening, wherein the decorative element is removably retained on the writing instrument. A decorative element is secured to the resilient member.

This application claims the benefit of priority to U.S. Provisional Patent Application No. 61/708,358 filed on Oct. 1, 2012, the entire contents of which are incorporated by reference herein for all purposes.

### FIELD OF INVENTION

The present invention relates to a device for decorating writing instruments. More particularly, the present invention relates to a device for decorating writing instruments including a resilient member removably securable to the writing instrument.

### BACKGROUND OF THE INVENTION

Devices for decorating writing instruments such as pens and pencils are known in the art. These devices typically include what are known as toppers that sit in the non-writing end of the instrument. These toppers, however, cover the pencil eraser or click actuator for pens and therefore need to be removed periodically. Other devices for decorating writing instruments are difficult to attach or remove, or obstruct comfortable writing.

In some applications, the decorative element is fixed to the writing instrument. Therefore, when the writing instrument is used up, the charm is discarded with the writing instrument.

Accordingly, it would be desirable to provide a decorative device for a writing instrument that easily allows the instrument to be customized, allows full use of the instrument and can be moved from one writing instrument to another.

### SUMMARY

The present invention provides a decorative writing instrument including a writing instrument and a resilient member having an opening therein. The writing instrument is disposed within the opening, wherein the decorative element is removably retained on the writing instrument. A decorative element is secured to the resilient member.

The present invention further provides to a decorating apparatus for a writing instrument including a decorative device removably securable to a writing instrument. The decorative device includes a resilient member having an opening for accommodating therein the writing instrument and a decorative element secured to the resilient member.

The present invention still further provides a decorative writing instrument including a generally elongate writing instrument. A first decorative device includes a resilient member having an opening therein. The writing instrument is disposed within the opening wherein the first decorative device is removably retained on the writing instrument. A first decorative element is secured to the resilient member. A second decorative device includes a second resilient member having an opening therein. The writing instrument is disposed within the opening wherein the second decorative element is removably retained on the writing instrument. A decorative element is secured to the resilient member. The second decorative device is spaced along a length of the writing instrument from the first decorative device.

### BRIEF DESCRIPTION OF THE DRAWINGS

FIGS. 1 is a perspective view of a writing instrument including decorative devices in accordance with the present invention;

FIGS. 2 front view of a decorative device of the present invention;

FIG. 3 is a detail view of a decorative device attached to a writing instrument; plan view of a resilient member and an attachment member.

FIG. 4 is a cross-sectional view of the resilient member taken along line 4-4 of FIG. 2.

FIG. 5 a top view of an attachment member of the present invention;

FIGS. 6 and 7 are perspective views of a writing instrument including a decorative device having pliable members;

FIG. 8 is a perspective view of a writing instrument including a decorative device in band form; and

FIG. 9 is a perspective view of a writing instrument including a plurality of decorative devices forming a unitary figure.

### DETAILED DESCRIPTION OF THE PREFERRED EMBODIMENTS

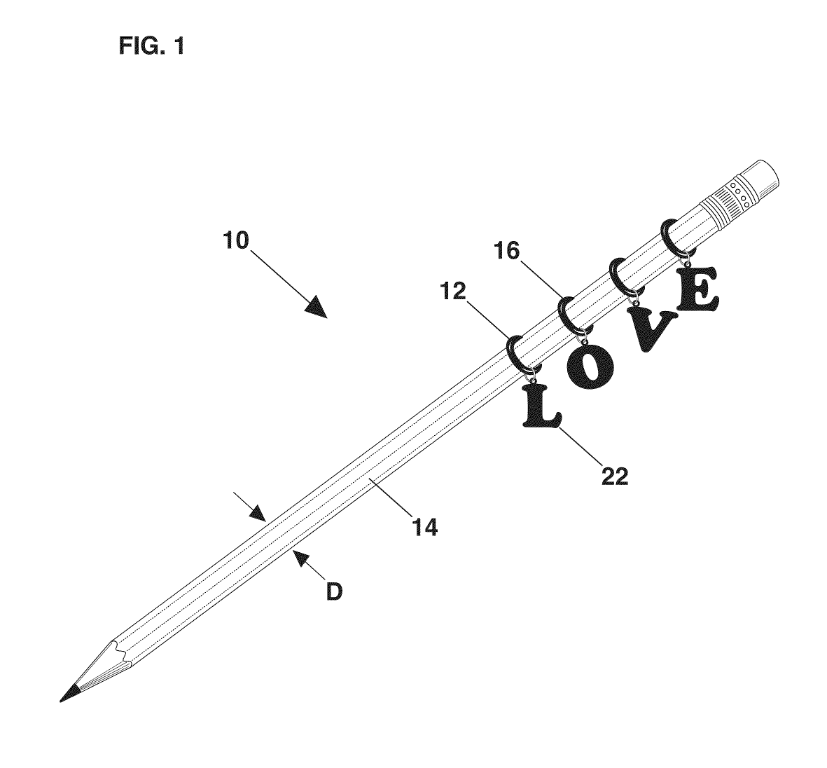

With reference to FIGS. 1-3, a decorative writing instrument 10 including a decorative device 12 disposed on an elongate writing instrument 14 is shown. The decorative device 12 includes a resilient member 16 having a generally round center opening 18 and a decorative element 22 secured thereto. The decorative element 22 may be in the form of charms, beads, rings, jewelry, figures, feathers, balls, erasers, or other type of decorative structure.

The resilient member 16 may be formed of an elastomeric material such as natural or synthetic rubber, silicone, or other resilient material which is able to repeatedly expand and contract. The resilient member 16 may be sized such that its central opening 18 can accommodate within the diameter D of a writing instrument 14 such as a pencil, pen or stylus such as that is used on handheld computing devices.

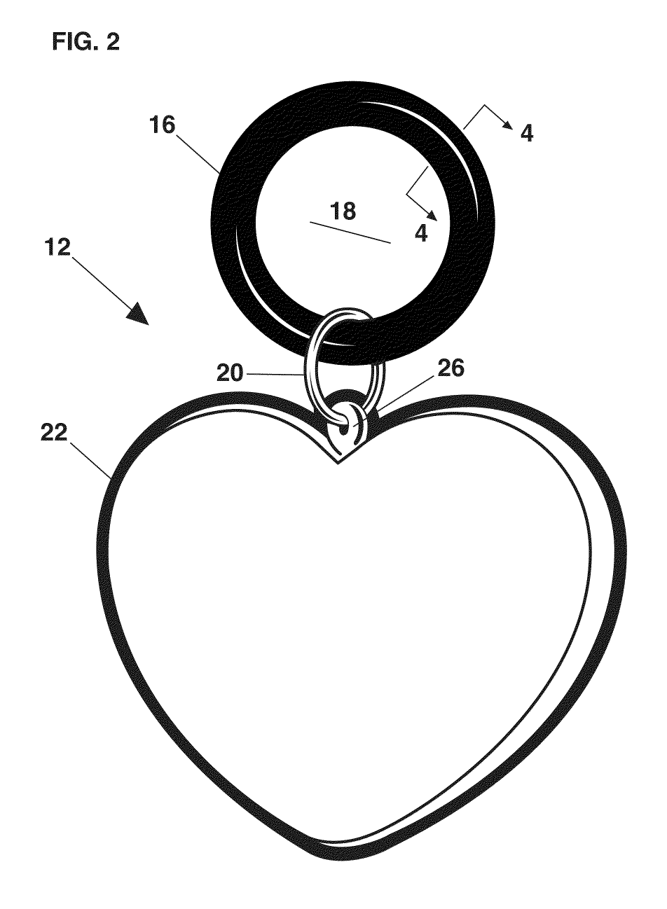

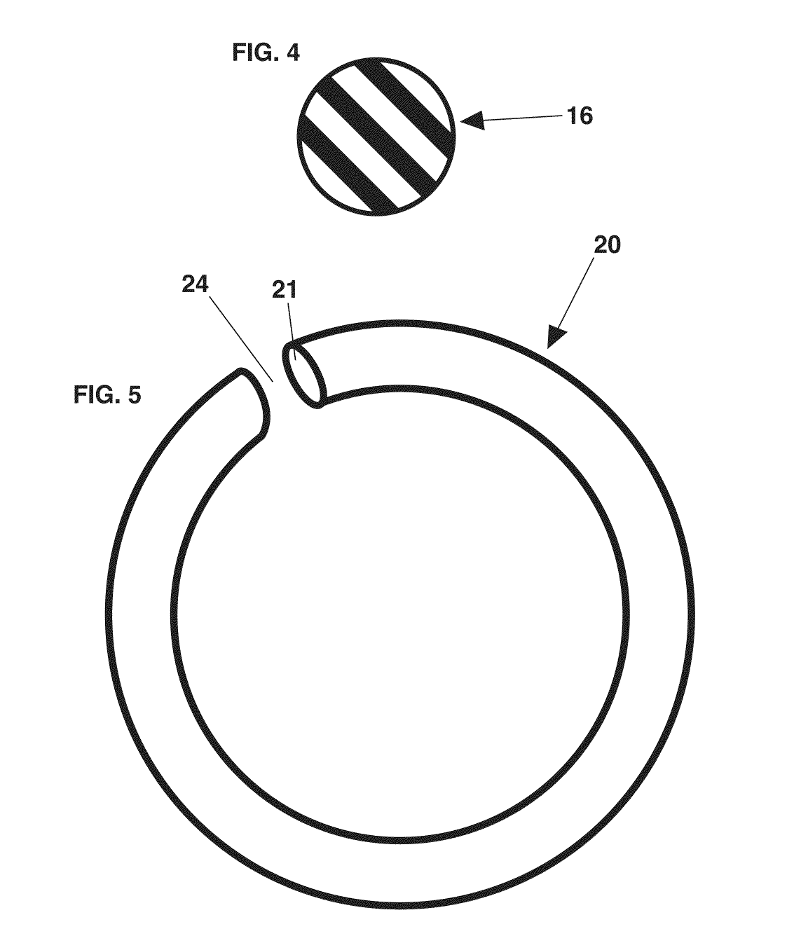

With additional reference to FIGS. 2 and 4, the resilient member 16 may be in the form of an O-ring having a generally circular cross-section with rounded edges. The resilient member 16 may be stretchable such that it can accommodate a wide variety of writing instruments 14 inserted therethrough. When a writing instrument 14 is inserted into the center opening 18 of the resilient member, it will stretch the resilient member 16. The resilient member is retained on the writing instrument 14 through a compression force created by the contracting resilient member 16. Once on the writing instrument 14, the user may slide the resilient member 16 up and down the length of the writing instrument in order to position it at a desired portion. The resilient member 16 may be slid on and off the writing instrument 14 so that it may be transferred to a different writing instrument. Accordingly, the resilient member 16 securely retains the decorative device on the writing instrument, but also allows the decorative devices to be easily removed and attached to the writing instrument.

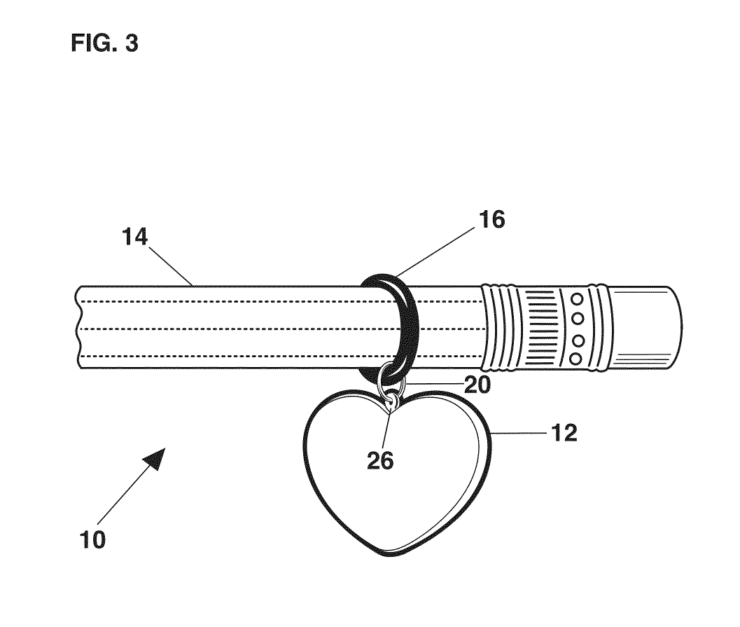

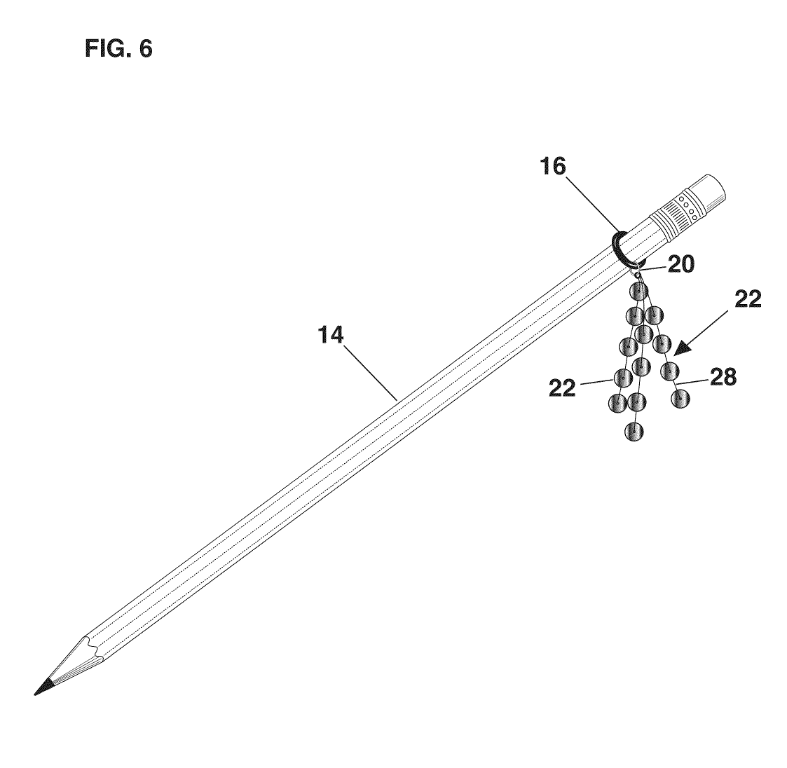

With additional reference to FIG. 5, the resilient member 16 may be joined to an attachment member 20 such as a metallic ring or clasp. The attachment member 20 secures the decorative element 22 to the elastic member 16. The attachment member 20 may be a split metal ring such that its ends 21 can be separated to form an open space 24. The resilient member 16 may be inserted into the attachment member through the space 24. In order to secure the decorative element 22 to the attachment member 20, the decorative element 22 may include a loop 26 which receives an end 21 of the attachment member. After the decorative element and resilient member are contained on the attachment member 16, the opposed ends 21 of the attachment member 20 may be urged back together closing the space 24. This secures the attachment member 20 and the decorative element 22 to the resilient member 16 as shown in FIG. 3.

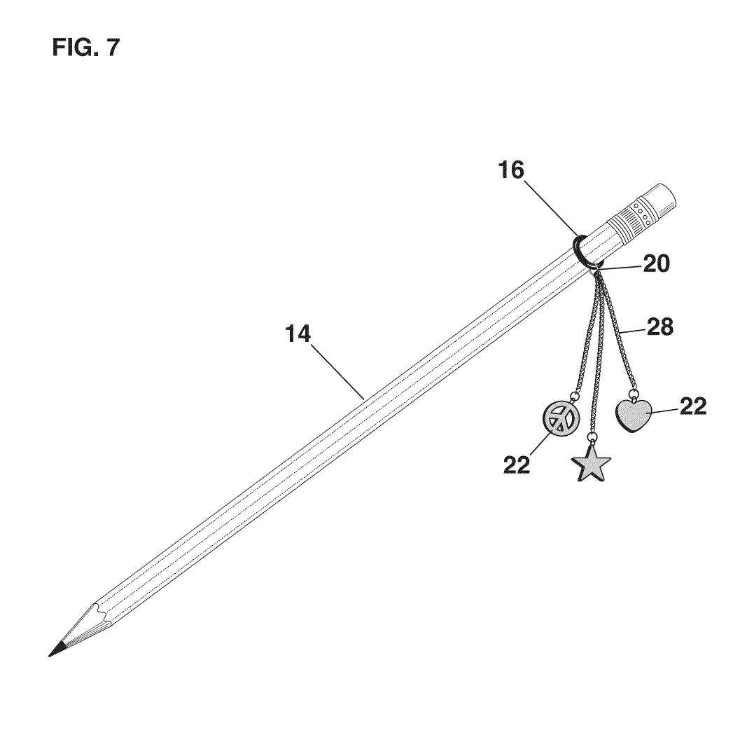

In one embodiment shown in FIGS. 6 and 7, one end of a pliable member 28 such as a string (FIG. 6) or chain (FIG. 7) may be secured to the resilient member 16 by attachment member 20 and extend outwardly therefrom. The other end of the pliable member may be secured to one or more decorative elements 22. In addition, the pliable members 28 may be formed of varying length in order to achieve a desired aesthetic appearance. In this way, the decorative elements 22 would be spaced from each other making them each individually more distinguishable. The pliable member 28 may also be strung with beads (FIG. 6) or other ornamentation.

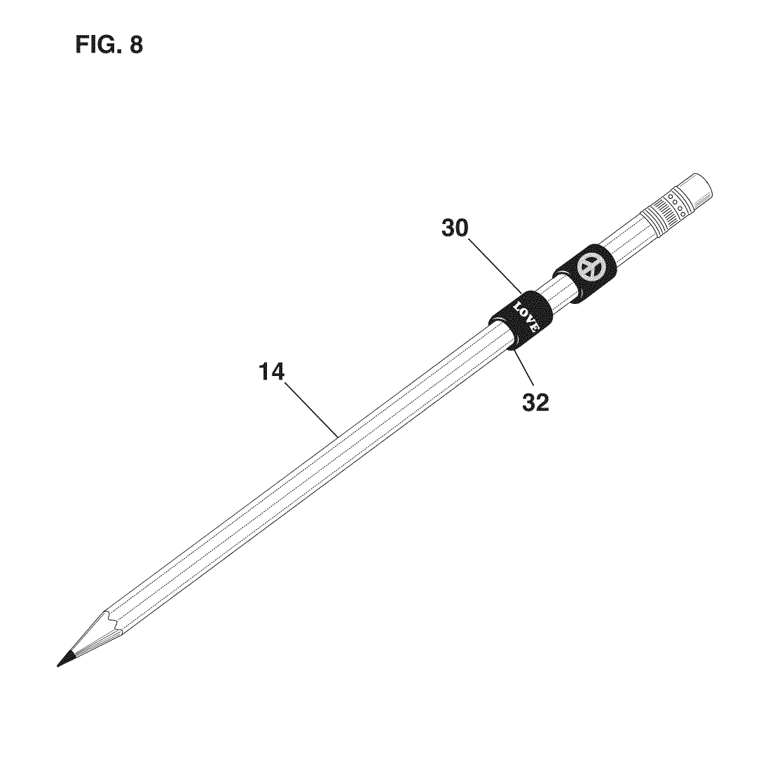

In a further embodiment shown in FIG. 8, the elastomeric member may be a sleeve-type member 30. The sleeve may be formed of an elastomeric material so that it can be stretched over writing instruments having a variety of widths. In addition, the sleeve 30 may have a generally planar longitudinally extending sidewall 32. Indicia 34 may be printed on the sleeve 30 in order to provide a decorative effect. The decorative sleeve 30 may be used alone or in combination with other decorative sleeves and/or with other decorative devices including decorative elements 22 thereon.

As shown in FIG. 1, a user may add a plurality of decorative devices 12 to one writing instrument 14. The plurality of decorative devices 12 may be spaced from each other along the length of the writing instrument as shown in FIG. 1. The user may mix and match a plurality of decorative devices 12 to achieve a desired aesthetic effect. For example, for decorative devices having letters as the decorative element 22, the user can arrange the decorative devices 12 to form names or other words. Users can also select decorative devices 12 to create certain themes, such as animals, sports, stars, etc. The ability to easily remove and attach the decorative devices 12 from the writing instrument also allows users to exchange or trade the decorative devices 12 with each other.

The decorative elements 22 may be formed of any number of materials for example, plastic resin, silicone, metal, wood, feathers, and rubber. The decorative elements may be formed of eraser material such that they can be used to erase writing, such as pencil or erasable ink. The eraser material may be of a type known in the art such as rubber, thermoplastic rubber, synthetic rubber, vinyl, etc.

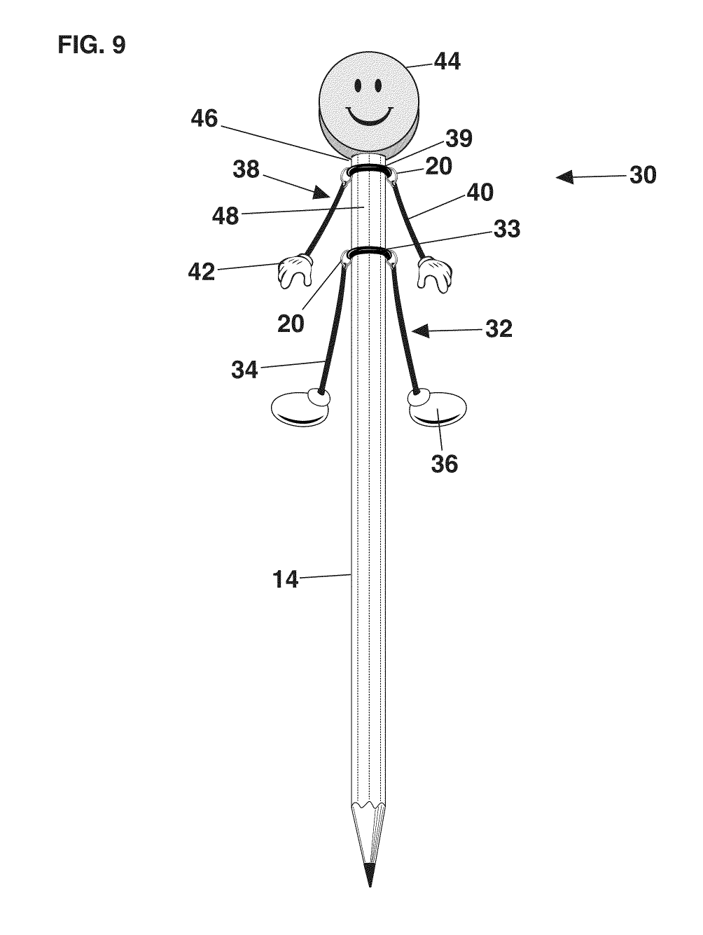

With reference to FIG. 9, in an alternative embodiment, a plurality of decorative devices 12 can be used to create a decorative unitary figure or character 30 on the writing instrument 14. The unitary figure may be in the form of a person, animal, cartoon character, flower, or other structure or form. In a preferred embodiment, the first decorative device 32 may include a lower body portion in the form of a leg device including a first resilient member 33 of a type described above. Attached to and depending from the resilient member 33 by an attachment member 20 is a pair of elongate members 34 that resemble legs. The distal end of the legs 34 includes elements resembling feet 36. The leg-like elongate members 34 may be formed of a pliable material, such as plastic covered wire, that when bent holds its position such that the legs can be bent to create different poses. A second decorative device 38 may be an upper body portion in the form of an arm device including a second resilient member 39 attached to two elongate members 40 resembling arms by attachment members 20. The arm-like elongate members 40 may be formed of a pliable material, such as plastic covered wire, that holds its position such that the arms can be bent to create different poses. The distal end of these arm-like members may be elements that resemble hands 42.

It is also contemplated that the arm 40 and leg 34 members could be formed of a non-shape holding material such as a chain, string cord, etc., which does not retain a particular position when moved. This would allow the hands 42 and feet 36 to move about when the writing instrument 14 is moved.

A third decorative device 44 may be in the form of a head of the decorative figure. The third decorative device may be a topper-like device 44 having a hole 46 therein to receive the end of the writing instrument. The head 44 may include facial features to give the appearance of a head. The third decorative device 44 could be formed of eraser material so that it can be used to erase writing.

When the three decorative devices 32, 38, and 44 are placed on the writing instrument, they, in conjunction with the writing instrument, cooperate to form a unitary FIG. 30. The user can mix and match the various elements to create unique and distinctive figures.

In order to assembly the unitary FIG. 30, the first resilient member 33 of the leg device 32 may be slid onto the writing instrument 14. The second resilient member 39 of the arm device 38 may then be slid onto the writing instrument 14 and spaced from the first resilient member 33. The spacing may be such to give the appearance of a character with arms, hands, legs, feet and body. The space 48 between the two resilient members gives the appearance of a body which is formed by the writing instrument. The third decorative device 44 may be placed on the end of the writing instrument to give the character a head. The space between the second decorative device 38 and the third decorative device 44 may form a neck of the figure. The first and second resilient members as well as the writing instrument and head give the appearance of the figure.

Various changes to the foregoing described and shown structures would now be evident to those skilled in the art. Accordingly, the particularly disclosed scope of the invention is set forth in the following claims.

What is claimed is:

1. A decorative writing instrument comprising:
a writing instrument;
a resilient member having an opening therein, the writing instrument disposed within the opening wherein the decorative element is removably retained on the writing instrument, a decorative element being secured to the resilient member.

2. The decorative writing instrument as defined in claim 1, wherein an attachment device is disposed between the decorative element and the resilient member for fixedly securing the decorative element to the resilient member.

3. The decorative writing instrument as defined in claim 1, wherein the resilient member includes an O-ring device having a generally circular cross-section.

4. The decorative writing instrument as defined in claim 1, wherein the attachment device includes a ring securably attached to the resilient member and to the decorative element.

5. The decorative writing instrument as defined in claim 1, wherein a pliable member is properly secured to the resilient member at one end and to a decorative element at the other end.

6. The decorative writing instrument as defined in claim 1, further including a plurality of pliable members each having a different length.

7. The decorative writing instrument as defined in claim 1, wherein the decorative element includes a sleeve having a longitudinal extent.

8. The decorative writing instrument as defined in claim 7, wherein the sleeve has a generally planar longitudinally extending sidewall.

9. A decorating apparatus for a writing instrument comprising:
a first decorative device removably securable to a writing instrument, the decorative device including a first resilient member having an opening for accommodating therein the writing instrument and a decorative element being secured to the resilient member.

10. The decorating device as defined in claim 9, wherein the first decorative device includes a first pair of elongate members extending therefrom ending in hand-shaped elements, and further including a second decorative device removably securable to a writing instrument, the decorative element including a second resilient member having an opening for accommodating therein the writing instrument and including a second pair of elongate members extending therefrom ending in foot-shaped elements.

11. The decorating device as defined in claim 10, further including a third decorative device having a hole therein for receiving an end of the writing instrument, the third decorative element being in the shape of a head.

12. The decorating device as defined in claim 10, wherein the first and second pair of resilient members are pliable members that are bendable and retain their shape after bending.

13. The decorating device as defined in claim 10, wherein the first and second pair of resilient members are pliable members that do not retain their shape when bent.

14. The decorating device as defined in claim 10, wherein the decorative element is formed of eraser material.

15. The decorating device as defined in claim 10, wherein a plurality of pliable elongate members are secured to the resilient member and a decorative element is to each of the pliable members.

16. A decorative writing instrument comprising:
a generally elongate writing instrument;
a first decorative device including a resilient member having an opening therein, the writing instrument disposed within the opening wherein the first decorative device is removably retained on the writing instrument, a first decorative element being secured to the resilient member; and
a second decorative device including a second resilient member having an opening therein, the writing instrument disposed within the opening wherein the second decorative device is removably retained on the writing instrument, a decorative element being secured to the resilient member, the second decorative device being spaced along a length of the writing instrument from the first decorative device.

17. The writing instrument as defined in claim 16, further including a third decorative device disposed on an end of the writing instrument, the first, second, and third decorative devices cooperating to form a unitary figure.

18. The writing instrument as defined in claim 17, wherein the first decorative element includes legs of the unitary figure and the second decorative device includes arms of the figure, the third decorative device forms a head of the figure, and the writing instrument forms the body of the figure.

19. The writing instrument as defined in claim 18, wherein the arms and legs of the figure are pliable members that are bendable and retain their shape after bending.

20. The writing instrument as defined in claim 16, wherein at least one of the first and second decorative elements is formed of eraser material.
